(19) United States
(12) Patent Application Publication
(10) Pub. No.: US 2026/0222416 A1
(43) Pub. Date: Jul. 30, 2026

(54) AUTHORIZATION METHOD AND APPARATUS, AND DEVICE AND STORAGE MEDIUM

(71) Applicant: BEIJING XIAOMI MOBILE SOFTWARE CO., LTD., Beijing (CN)

(72) Inventors: Haoran LIANG, Beijing (CN); Wei LU, Beijing (CN)

(73) Assignee: BEIJING XIAOMI MOBILE SOFTWARE CO., LTD., Beijing (CN)

(21) Appl. No.: 19/145,564

(22) PCT Filed: Jan. 5, 2023
(86) PCT No.: PCT/CN2023/070737

§ 371 Date: Jul. 3, 2025

(51) Int. Cl. H04L 9/40

(52) U.S. Cl. CPC H04L 63/108

(57) ABSTRACT

An authorization method, performed by a first device, is provided, and includes: receiving a terminal information provision request, wherein the terminal information provision request comprises first information of a terminal, and the first information of the terminal is provisioned by an application function (AF); determining indication information, wherein the indication information indicates an allowable provision condition for the first information of the terminal; and authorizing, based on the indication information, the AF to perform a provision procedure of the first information.

### CROSS-REFERENCE TO RELATED APPLICATION

The present application is a U.S. national phase of International Application No. PCT/CN2023/070737, filed on Jan. 5, 2023, the content of which is incorporated herein by reference in its entirety.

### TECHNICAL FIELD

The disclosure relates to the field of communication technologies, and in particular, to an authorization method, an apparatus, a device, and a storage medium.

### BACKGROUND

In a non-terrestrial network (NTN) communication system, an application function (AF) typically provides unreachability period information of a terminal to an access and mobility management function (AMF) network element and/or a mobility management entity (MME).

### SUMMARY

The disclosure proposes an authorization method, an apparatus, a device, and a storage medium.

In a first aspect, the embodiments of the disclosure provide an authorization method, including:
receiving a terminal information provision request, in which the terminal information provision request includes first information of a terminal, and the first information of the terminal is provisioned by an application function (AF);
determining indication information, in which the indication information indicates an allowable provision condition for the first information of the terminal; and
authorizing, based on the indication information, a provision procedure of the first information by the AF.

In a second aspect, the embodiments of the disclosure provide an authorization method, including:
receiving first information of a terminal, in which the first information of the terminal is provisioned by an AF;
sending the first information of the terminal.

In a third aspect, the embodiments of the disclosure provide an authorization method, including:
sending a terminal information provision request to a first network function (NF), in which the terminal information provision request includes first information of a terminal provisioned by an AF; and
receiving a success response message or a rejection response message sent by the first NF.

In a fourth aspect, the embodiments of the disclosure provide an authorization method, including:
sending indication information to a second NF, in which the indication information indicates an allowable provision condition for the first information of the terminal.

In a fifth aspect, the embodiments of the disclosure provide a communication apparatus, including a processor and a memory, in which the memory stores a computer program, and the processor executes the computer program stored in the memory to enable the communication apparatus to perform the method according to any one of the first to fourth aspects.

In a sixth aspect, the embodiments of the disclosure provide a non-transitory computer-readable storage medium for storing instructions, in which when the instructions are executed, the terminal performs the method according to any one of the first to fourth aspects.

### BRIEF DESCRIPTION OF THE DRAWINGS

The above and/or additional aspects and advantages of the disclosure will become apparent and readily understood from the following description of embodiments in conjunction with the drawings.

FIG. 1 is a schematic diagram of a communication system according to an embodiment of the disclosure.

FIG. 2a is a schematic flowchart of an authorization method according to an embodiment of the disclosure.

FIG. 2b is a schematic flowchart of an authorization method according to another embodiment of the disclosure.

FIG. 2c is a schematic flowchart of an authorization method according to further another embodiment of the disclosure.

FIG. 3a is a schematic flowchart of an authorization method according to yet another embodiment of the disclosure.

FIG. 3b is a schematic flowchart of an authorization method according to yet another embodiment of the disclosure.

FIG. 4 is a schematic flowchart of an authorization method according to yet another embodiment of the disclosure.

FIG. 5 is a schematic flowchart of an authorization method according to yet another embodiment of the disclosure.

FIG. 6a is a schematic flowchart of an authorization method according to yet another embodiment of the disclosure.

FIG. 6b is a schematic flowchart of an authorization method according to yet another embodiment of the disclosure.

FIG. 6c is a schematic flowchart of an authorization method according to yet another embodiment of the disclosure.

FIG. 6d is schematic flowchart of an authorization method according to yet another embodiment of the disclosure.

FIG. 7 is an interaction flowchart of a first network function (NF) subscribing to indication information from a second NF according to an embodiment of the disclosure.

FIG. 8 is an interaction flowchart of an authorization method according to an embodiment of the disclosure.

FIG. 9 is a schematic diagram of an authorization apparatus according to an embodiment of the disclosure.

FIG. 10 is a schematic diagram of an authorization apparatus according to another embodiment of the disclosure.

FIG. 11 is a schematic diagram of an authorization apparatus according to further another embodiment of the disclosure.

FIG. 12 is a schematic diagram of an authorization apparatus according to yet another embodiment of the disclosure.

FIG. 13 is a schematic diagram of a communication apparatus according to an embodiment of the application.

FIG. 14 is a schematic diagram of a chip according to an embodiment of the application.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the example embodiments do not represent all implementations consistent with the disclosure. Instead, they are merely examples of apparatuses and methods consistent with aspects related to the disclosure as recited in the attached claims.

The terms used in the disclosure are only for the purpose of describing specific embodiments, and are not intended to limit the disclosure. The singular forms of “a” and “the” used in the disclosure and attached claims are also intended to include plural forms, unless the context clearly indicates other meanings. It is understandable that the term “and/or” as used herein refers to and includes any or all possible combinations of one or more associated listed items.

It is understandable that although the terms “first”, “second”, and “third” may be used in the disclosure to describe various information, the information should not be limited to these terms. These terms are only used to distinguish the same type of information from each other. For example, without departing from the scope of the disclosure, the first information may also be referred to as the second information, and similarly, the second information may also be referred to as the first information. Depending on the context, the term “if” as used herein may be interpreted as “when”, “while” or “in response to determining”.

The embodiments of the disclosure are described in detail below, and examples of the embodiments are shown in the drawings, in which the same or similar reference numerals represent the same or similar elements throughout. The embodiments described below with reference to the drawings are exemplary and are intended to explain the disclosure, but should not be construed as a limitation to the disclosure.

For ease of understanding, terms involved in this application are first introduced.

### 1. Access and Mobility Management Function (AMF) Network Element

The AMF network element supports a terminal with different mobility management requirements, and is able to perform the following main tasks: a non-access stratum (NAS) signaling terminal; NAS signaling security; access layer security control; a core network inter node signaling for mobility between 3rd generation partnership project (3GPP) access networks; an idle mode terminal reachability (including control and execution of paging retransmission); registration area management; supporting for intra-system and inter-system mobility; access authentication; access authorization, including roaming permission checking; mobility management control (subscription and policy); supporting for network slicing; and session management function (SMF) selection.

The above-mentioned AMF network element, NAS signaling, 3GPP, and SMF are exemplary descriptions of the disclosure. The disclosure does not specifically limit these names, and other network elements that are able to achieve similar functions are also within the protection scope of the disclosure.

### 2. Unified Data Management Function (UDM)

The UDM is configured to undertake functions related to data management, such as the authentication credential repository and processing function (ARPF), which may select an identity authentication method according to a user identity and a configuration policy, and calculate identity authentication data and key for the authentication server function (AUSF) when needed.

The above-mentioned UDM, ARPF, and AUSF are exemplary descriptions of the disclosure. The disclosure does not specifically limit these names, and other network elements that are able to achieve similar functions are also within the protection scope of the disclosure.

### 3. Application Function (AF)

The AF may be configured to provide 5th generation (5G) network capabilities for an edge application. The edge application achieves open capability acquisition via an interface between the AF and a network exposure function (NEF) network element.

The above-mentioned AF and NEF are exemplary descriptions of the disclosure. The disclosure does not specifically limit these names, and other network elements that are able to achieve similar functions are also within the protection scope of the disclosure.

### 4. Network Function (NF)

The system architecture of 5G is service based architecture (SBA), and the elements in the system architecture are defined as some NFs composed of services. Each NF provides services via service-based interfaces and allows other NFs to access or invoke its own services. All NFs achieve automated management via a network function repository function (NRF).

The above-mentioned NF, SBA, and NRF are exemplary descriptions of the disclosure. The disclosure does not specifically limit these names, and other network elements that are able to achieve similar functions are also within the protection scope of the disclosure.

In a communication system, different AFs are authorized to provide unreachability period information of different terminals. However, it may occur that an AF provides the core network with unreachability period information of a terminal that is not within an authority of the AF via an NEF network element and/or MME. That is, the unreachability period information provided by the AF is not the unreachability period information of for the terminal which is allowed to provide. At this time, the unreachability period information provided by the AF may be incorrect, which may mislead the core network to perform a Denial of Service (DoS) attack on the terminal. For example, the core network may be misled to abnormally interrupt communication of the terminal, resulting in service interruption, or the core network may be misled to provide inappropriate mobility management parameters and/or power-saving parameters to the terminal, affecting a service processing of the terminal.

Based on this, the disclosure proposes an authorization method.

To better understand an authorization method disclosed in the embodiments of the disclosure, a communication system applicable to the embodiments of the disclosure is first described below.

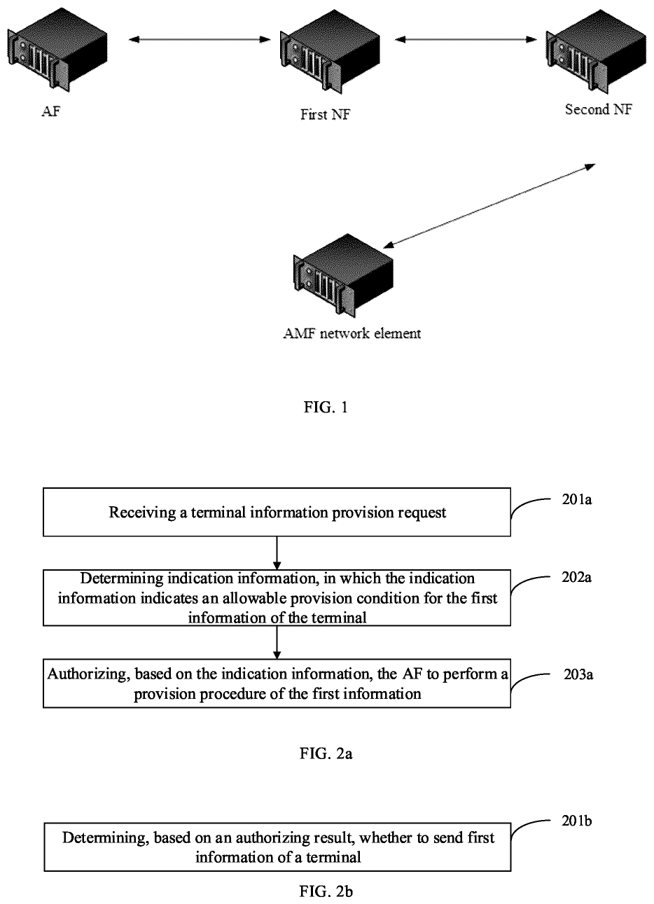

Please refer to FIG. 1, which is a schematic diagram of a communication system provided by an embodiment of the disclosure. The communication system may include, but is not limited to, a first NF, an AF, a second NF, and an AMF network element. In some embodiments, the number and form of devices shown in FIG. 1 are used for illustration and do not constitute a limitation to the embodiments of the disclosure. In practical applications, there may be one or more first NFs included, one or more AFs included, one or more second NFs included, or one or more AMF network elements included. In some embodiments, the communication system shown in FIG. 1 takes the case of including one first NF, one AF, one second NF, and one AMF network element as an example.

It should be noted that the technical solutions of the embodiments of the disclosure may be applied to various communication systems, such as a long term evolution (LTE) system, a 5G mobile communication system, a 5G new radio (NR) system, or other future new mobile communication systems, etc.

It may be understood that the communication system described in the embodiments of the disclosure is intended to more clearly illustrate the technical solutions of the embodiments of the disclosure, and does not constitute a limitation to the technical solutions provided by the embodiments of the disclosure. Those of ordinary skill in the art know that with the evolution of the system architecture and the emergence of new service scenarios, the technical solutions provided by the embodiments of the disclosure are also applicable to similar technical problems.

The authorization method, apparatus, device, and storage medium provided by the embodiments of the disclosure are described in detail below with reference to the drawings.

It should be noted that, in the disclosure, the authorization method provided in any embodiment may be executed alone, any implementation in the embodiments may also be executed alone, or may be executed in combination with other embodiments, or with possible implementations in other embodiments, and may also be executed in combination with any technical solution in the related art.

In the disclosure, the wording “sending” mentioned may include direct sending, indirect sending, transparent sending, etc. For example, “the AF sends a terminal information provision request to a first NF” may include: the AF directly sends the terminal information provision request to the first NF, or the AF first sends the terminal information provision request to an intermediate device, and the intermediate device forwards or transparently sends the terminal information provision request to the first NF. Similarly, the wording “receiving” mentioned in the disclosure may also include direct receiving, indirect receiving, transparent receiving, etc. For example, “the first NF receives the terminal information provision request sent by the AF” may include: the first NF directly receives the terminal information provision request sent by the AF, or the first NF receives the terminal information provision request forwarded or transparently sent by the intermediate device.

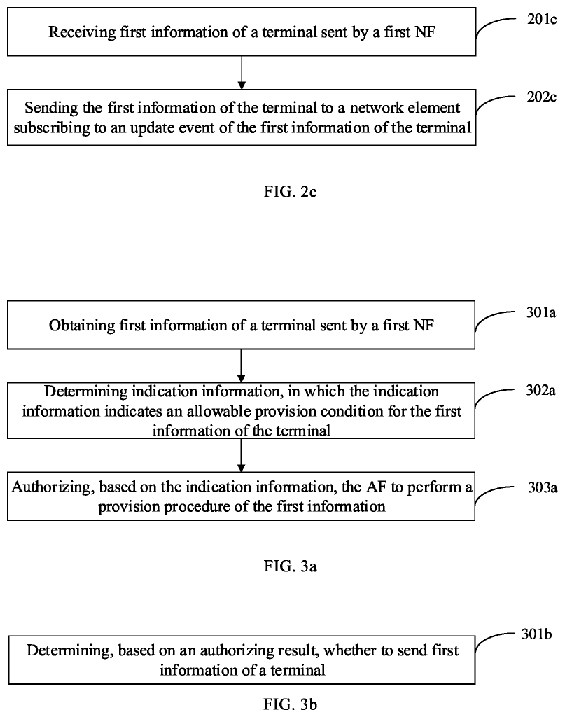

FIG. 2a is a schematic flowchart of an authorization method according to an embodiment of the disclosure. The method is performed by a first NF. As shown in FIG. 2a, the authorization method may include the following steps.

At step 201a, a terminal information provision request is received.

In some embodiments, in an embodiment of the disclosure, the terminal information provision request may be sent by an AF. Optionally, when the AF intends to provide information of a terminal to an AMF network element or an MME, the AF sends the terminal information provision request to the first NF to indicate that the AF requests to provide the information of the terminal to the AMF network element or the MME via the first NF. Optionally, the terminal information provision request may include first information, in which the first information may be the information of the terminal provisioned by the AF and planned to be provided by the AF to the AMF network element or the MME. In some embodiments, the first information may be unreachability period information of the terminal, or in other embodiments, the first information may also be other information related to the terminal, such as positioning information of the terminal, which is not limited in the disclosure.

In some embodiments, in an embodiment of the disclosure, the terminal information provision request may further include at least one of:
an identifier of an AF that provisions the first information;
an identifier of the terminal corresponding to the first information;
a first service identifier corresponding to the first information, in which the first service identifier indicates that: the AF processes the first information with a service corresponding to the first service identifier. In some embodiments, the service corresponding to the first service identifier may be understood as, for example, which services may be configured to process the first information provisioned by the AF. For example, the first service identifier may be Nnef_ParameterProvision; or
a first service operation identifier corresponding to the first information, in which the first service operation identifier indicates that: the AF processes the above-mentioned first information with a service operation corresponding to the first service operation identifier. In some embodiments, the service operation corresponding to the first service operation identifier may be understood as, for example, which service operations may be configured to process the first information provisioned by the AF. For example, the first expected service operation identifier may include at least one of Nnef_ParameterProvision_Update service operation, Nnef_ParameterProvision_Create service operation, Nnef_ParameterProvision_Delete service operation, and Nnef_ParameterProvision_Get service operation.

After receiving the terminal information provision request, the first NF may provide, based on the terminal information provision request, the first information of the terminal provisioned by the AF to the AMF network element or the MME via a second NF.

In some embodiments, in an embodiment of the disclosure, in a case where the first information of the terminal is the unreachability period information of the terminal, information content corresponding to the first information of the terminal may include at least one of:
a maximum waiting time corresponding to a transmission of the terminal (maximum latency);
a maximum response time of the terminal to information (maximum response);
a time the terminal is in coverage of a communication signal; or
a time the terminal is out of coverage of a communication signal.

In some embodiments, the above-mentioned coverage of the communication signal may include communication signal coverage of a terrestrial network and/or communication signal coverage of a non-terrestrial network.

In some embodiments, the above-mentioned first NF may include at least one of:
a NEF network element;
a common application programming interface (API) framework (CAPIF) core function;
an authorization function; or
an API exposing function (AEF).

In some embodiments, the above-mentioned second NF may include at least one of:
an UDM; or
an unified data repository (UDR).

At step 202a: indication information is determined, in which the indication information indicates an allowable provision condition for the first information of the terminal.

In some embodiments, since different AFs are authorized to provision the first information of different terminals, in an embodiment of the disclosure, after the first NF receives the first information of the terminal provided by the AF and before providing the first information of the terminal to the AMF network element or the MME via the second NF, the first NF may first determine whether the AF has an authority to provision the first information, so as to avoid a situation where “in a case where the AF provides first information of the terminal beyond its authority, but the first NF fails to identify this first information provided by the AF and directly provides the first information to the AMF network element or the MME via the second NF, resulting in a core network possibly performing a DoS attack on the terminal”.

In some embodiments, in an embodiment of the disclosure, the allowable provision conditions for the first information of the terminal may be determined by determining the indication information corresponding to the terminal, and then based on the allowable provision condition, whether the AF has the authority to provision the first information of the terminal may be determined.

In some embodiments, in an embodiment of the disclosure, the indication information may include at least one of:
an identifier of at least one target AF, in which the target AF is a network element allowed to provision the first information of the terminal;
an identifier of the terminal;
at least one piece of second information, in which the second information may indicate information allowed to be provisioned for the terminal;
an expected service identifier, provisioned to indicate that: the terminal allows the target AF to process the second information with an expected service corresponding to the expected service identifier;
an expected service operation identifier, provisioned to indicate that: the terminal allows the target AF to process the second information with an expected service operation corresponding to the expected service operation identifier;
a valid time of the indication information;
an expiration time of the indication information; or
an authorization policy, which includes that the terminal allows the target AF to process the second information with the expected service and/or the expected service operation.

In some embodiments, the above-mentioned target AF may be a network element allowed by the terminal to provision the first information, or a network element allowed by other devices to provision the first information. In some embodiments, the above “identifier of the target AF” may be at least one of an AF_ID of the target AF, a network application function (NAF) ID, an internet protocol (IP) address, an application layer ID, or a fully qualified domain name (FQDN).

In some embodiments, the above “identifier of the terminal” may be at least one of a subscription permanent identifier (SUPI), a subscription concealed identifier (SUCI), an IMS privacy user identity (IMPI), an application layer ID of the terminal, or a generic public subscription identifier (GPSI).

In some embodiments, the second information may include unreachability period information.

In some embodiments, the expected service may be understood as, for example, which services may be configured to process the second information. In some embodiments, the expected service identifier may be Nnef_ParameterProvision, etc.

In some embodiments, the expected service operation may be understood as, for example, which service operations may be configured to process the second information. In some embodiments, the expected service operation identifier may include at least one of Nnef_ParameterProvision_Update service operation, Nnef_ParameterProvision_Create service operation, Nnef_ParameterProvision_Delete service operation, and Nnef_ParameterProvision_Get service operation.

In some embodiments, the authorization policy is different from the above-mentioned items (such as the identifier of the target AF and the identifier of the terminal corresponding to the indication information) in that: the above-mentioned items are all saved or sent in the form of entries, while the authorization policy is a sentence. For example, the authorization policy may be: Terminal #1 allows AF #1 to process, via the Nnef_ParameterProvision service, the unreachability period information of Terminal #1.

In some embodiments, in another embodiment of the disclosure, the above-mentioned indication information may not include the identifier of the target AF but include the second information, that is, which information being able be provisioned is limited without limiting which AF is authorized to provision the information. Then, the indication information may include at least one of:
the identifier of the terminal;
at least one piece of second information, in which the second information may indicate the information allowed to be provisioned for the terminal;
the expected service identifier;
the expected service operation identifier;
the valid time of the indication information;
the expiration time of the indication information; or
the authorization policy, which includes that the terminal allows the second information to be processed with the expected service and/or the expected service operation.

In some embodiments, in an embodiment of the disclosure, the method for determining the indication information corresponding to the terminal may include at least one of:
method 1: determining, based on the identifier of the terminal, the indication information corresponding to the terminal from pre-provisioned indication information; or
method 2: determining, based on the identifier of the terminal, the indication information corresponding to the terminal from pre-stored indication information, in which the pre-stored indication information is obtained by the first NF by subscribing to or requesting from the second NF.

In some embodiments, the method for the first NF obtaining the pre-stored indication information by subscribing to the second NF may include: the first NF subscribing to an update event of the indication information from the second NF. In some embodiments, if the indication information of a certain terminal is updated (such as the identifier of the target AF is updated), the terminal may send an updated indication information to the AMF network element (for example, via an N1 NAS message), and the AMF network element may send the updated indication information to the second NF. For example, the AMF may invoke the Nudm_ParameterProvision_Update service operation for the second NF, where the Nudm_ParameterProvision_Update service operation carries the updated indication information, so as to send the updated indication information to the second NF. The second NF may then update the stored indication information based on the updated indication information, for example, update the stored indication information by correspondingly invoking the Nudr_DM_Update (SUPI, subscription data) service operation, and may send the updated indication information to the first NF that subscribes to the update event of the indication information, so as to achieve the above-mentioned “the first NF obtaining the pre-stored indication information by subscribing to the second NF”. In some embodiments, the first NF may also cancel the subscription to the update event of the indication information from the second NF.

In some embodiments, after the second NF updates and stores the indication information based on the updated indication information, the second NF may also return a response to the AMF, so that the AMF may send the response to the terminal (e.g., via an N1 NAS message) to inform the terminal that the second NF has completed updating and storing of the indication information.

In some embodiments, the first NF obtaining the pre-stored indication information by requesting the second NF may include: the first NF sending a request message to the second NF to request the indication information.

At step 203a: the AF is authorized, based on the indication information, to perform a provision procedure of the first information.

In some embodiments, in an embodiment of the disclosure, the above “authorizing, based on the indication information, the AF to perform the provision procedure of the first information” may be understood as, for example: determining whether the AF has an authority to provision the first information. In some embodiments, when it is determined that the AF has the authority to provision the first information, the first information may be subsequently sent to other devices in the core network, indicating that the AF successfully provisions the first information. When it is determined that the AF does not have the authority to provision the first information, sending the first information is terminated, indicating that the AF fails to provision the first information.

In some embodiments, in an embodiment of the disclosure, when the indication information includes different contents, the method for “authorizing, based on the indication information, the AF to perform the provision procedure of the first information” may also differ.

In an embodiment of the disclosure, when both the identifier of the target AF and the second information are limited in the indication information, the method for “authorizing, based on the indication information, the AF to perform the provision procedure of the first information” may include at least one of:
step 1: determining whether an AF for provisioning the first information is the target AF, and determine whether the first information is the second information.
step 2: in response to the first information being not the second information and/or the AF for provisioning the first information not being the target AF, determining that the authorizing fails; or
step 3: in response to the AF for provisioning the first information being the target AF and the first information being the second information, determining whether the authorizing passes or fails based on whether the indication information includes at least one of the expected service identifier or the expected service operation identifier, and/or based on whether the terminal information provision request includes at least one of the first service identifier or the first service operation identifier.

In some embodiments, the above-mentioned “determining whether the authorizing passes or fails based on whether the indication information includes at least one of the expected service identifier or the expected service operation identifier, and/or based on whether the terminal information provision request includes at least one of the first service identifier or the first service operation identifier” may include at least one of:
in response to the indication information not including the expected service identifier or the expected service operation identifier, determining that the authorizing passes;
in response to the indication information including the expected service identifier and the terminal information provision request including the first service identifier, determining whether the first service identifier belongs to the expected service identifier, and in a case where the first service identifier belongs to the expected service identifier, determining that the authorizing passes, and in a case where the first service identifier does not belong to the expected service identifier, determining that the authorizing fails;
in response to the indication information including the expected service operation identifier and the terminal information provision request including the first service operation identifier, determining whether the first service operation identifier belongs to the expected service operation identifier, and in a case where the first service operation identifier belongs to the expected service operation identifier, determining that the authorizing passes, and in a case where the first service operation identifier does not belong to the expected service operation identifier, determining that the authorizing fails;
in response to the indication information including the expected service identifier and the expected service operation identifier, and the terminal information provision request including the first service identifier and the first service operation identifier, determining whether the first service identifier belongs to the expected service identifier and whether the first service operation identifier belongs to the expected service operation identifier, and in a case where the first service identifier belongs to the expected service identifier and the first service operation identifier belongs to the expected service operation identifier, determining that the authorizing passes, and in a case where the first service identifier does not belong to the expected service identifier, or the first service operation identifier does not belong to the expected service operation identifier, determining that the authorizing fails;
in response to the indication information including the expected service identifier and the terminal information provision request not including the first service identifier, determining that the authorizing fails; or
in response to the indication information including the expected service operation identifier and the terminal information provision request not including the first service operation identifier, determining that the authorizing fails.

In some embodiments, the above-mentioned “the first service identifier belongs to the expected service identifier” may be understood as, for example: the first service identifier is consistent with the expected service identifier. For example, when both the first service identifier and the expected service identifier are Nnef_ParameterProvision, it is considered that the first service identifier belongs to the expected service identifier. The above-mentioned “the first service operation identifier belongs to the expected service operation identifier” may be understood as, for example: the first service operation identifier is consistent with the expected service operation identifier. For example, when both the first service operation identifier and the expected service operation identifier are Nnef_ParameterProvision_Update service operation, it is considered that the first service operation identifier belongs to the expected service operation identifier.

In some embodiments, in an embodiment of the disclosure, the process of the above-mentioned “authorizing, based on the indication information, the AF to perform the provision procedure of the first information” may include the step 1 and the step 2. In another embodiment of the disclosure, the process of the above-mentioned “authorizing, based on the indication information, the AF to perform the provision procedure of the first information” may include the step 1 and the step 3. In some embodiments, the process of the above-mentioned “authorizing, based on the indication information, the AF to perform the provision procedure of the first information” may include the step 1, the step 2, and the step 3.

In another embodiment of the disclosure, when the indication information does not include the target AF but includes the second information, the method for “authorizing, based on the indication information, the AF to perform the provision procedure of the first information” may include at least one of:
step a: determining whether the first information is the second information;
step b: in response to the first information being the second information, determine that the authorizing fails;
step c: in response to the first information being not the second information, determine whether the authorizing passes or fails based on whether the indication information includes at least one of the expected service identifier or the expected service operation identifier, and/or based on whether the terminal information provision request includes at least one of the first service identifier or the first service operation identifier.

The detailed description of step c may refer to the description of above step 3.

In some embodiments, in an embodiment of the disclosure, the process of the above-mentioned “authorizing, based on the indication information, the AF to perform the provision procedure of the first information” may include the step a and the step b. In another embodiment of the disclosure, the process of the above-mentioned “authorizing, based on the indication information, the AF to perform the provision procedure of the first information” may include the step a and the step c. In some embodiments, the process of the above-mentioned “authorizing, based on the indication information, the AF to perform the provision procedure of the first information” may include the step a, step b, and step c.

As can be seen from the above, in an embodiment of the disclosure, during the process of authorizing, based on the indication information, the AF to perform the provision procedure of the first information, it is determined that the authorizing passes in a case of determining that the AF has the authority to provision the first information and a provision condition of the first information by the AF meets the allowable provision condition of the first information. In a case of determining that the AF does not have the authority to provision the first information of the terminal, and/or the provision condition of the first information of the terminal by the AF does not meet the allowable provision condition of the first information, it is determined that the authorizing fails. Therefore, subsequently, the first information provisioned by the AF with the provision authority and meeting the allowable provision condition may be authorized for sending based on the authorizing result, while the first information provisioned by the AF without the provision authority and/or the first information provisioned by the AF with the provision authority but not meeting the allowable provision condition is not authorized for sending, thus improving a strictness for sending information and avoiding a situation where “in a case where the AF provides first information of the terminal beyond its authority, but the first NF fails to identify this first information provided by the AF and directly provides the first information to the AMF network element or the MME via the second NF, resulting in a core network possibly performing a DoS attack on the terminal”, and ensuring a stability of communication.

In some embodiments, optional examples of the embodiment in FIG. 2a of the disclosure and other embodiments (such as at least one of the embodiments in FIGS. 2b and 2c, or FIGS. 3 to 6d) may be combined with each other.

In summary, according to the authorization method provided by the embodiments of the disclosure, after the first NF receives the first information of the terminal provided by the AF, before sending the first information, the first NF may first authorize, based on the indication information, the AF to perform the provision procedure of the first information. In some embodiments, the indication information indicates the allowable provision condition of the first information of the terminal. Then, “authorizing, based on the indication information, the AF to perform the provision procedure of the first information” may be understood as, for example, determining whether the AF has the authority to provision the first information, so as to determine, based on the authorizing result, whether to send the first information subsequently, thereby improving a strictness for sending information and avoiding a situation where “in a case where the AF provides first information of the terminal beyond its authority, but the first NF fails to identify this first information provided by the AF and directly provides the first information to the AMF network element or the MME via the second NF, resulting in a core network possibly performing a DoS attack on the terminal”, and ensuring a stability of communication.

FIG. 2b is a schematic flowchart of an authorization method according to an embodiment of the disclosure. The method is executed by a first NF. As shown in FIG. 2b, the authorization method may include the following steps.

At step 201b: it is determined, based on an authorizing result, whether to send first information of a terminal.

In some embodiments, the method for determining, based on the authorizing result, whether to send the first information of the terminal may include at least one of:
in response to the authorizing passing, sending the first information of the terminal to a second NF, so that after the second NF receives the first information, the second NF updates and stores the first information based on the content of the first information, and may send the received first information of the terminal to the network element subscribing to an update event of the first information of the terminal. In some embodiments, the network elements subscribing to the update event of the first information of the terminal may include an AMF network element and/or an MME, thereby realizing that “the AF provides (or provisions) terminal information to the AMF network element and/or the MME”; or
in response to the authorizing failing, terminating sending the first information of the terminal, while sending a rejection response message to the AF.

In some embodiments, in an embodiment of the disclosure, the process of the above-mentioned “the method for determining, based on the authorizing result, whether to send the first information of the terminal” may include: in response to the authorizing passing, sending the first information of the terminal to the second NF. In another embodiment of the disclosure, the process of the above-mentioned “the method for determining, based on the authorizing result, whether to send the first information of the terminal” may include: in response to the authorizing failing, terminating sending the first information of the terminal. In yet another embodiment of the disclosure, the process of the above-mentioned “the method for determining, based on the authorizing result, whether to send the first information of the terminal” may include: in response to the authorizing passing, sending the first information of the terminal to the second NF; and in response to the authorizing failing, terminating sending the first information of the terminal.

In some embodiments, in an embodiment of the disclosure, after the first NF sends the first information of the terminal to the second NF, the first NF will also obtain a success response message sent by the second NF and send a success response message to the AF.

In some embodiments, optional examples of the embodiment in FIG. 2b of the disclosure and other embodiments (such as at least one of the embodiments in FIGS. 2a and 2c, or FIGS. 3 to 6d) may be combined with each other.

In summary, according to the authorization method provided by the embodiments of the disclosure, the first information is sent only when the authorizing passes, and sending the first information of the terminal is terminated when the authorizing fails. Therefore, the method of the disclosure has a high strictness for sending information, ensuring a stability of communication.

FIG. 2c is a schematic flowchart of an authorization method according to an embodiment of the disclosure. The method is executed by a second NF. As shown in FIG. 2c, the authorization method may include the following steps.

At step 201c: first information of a terminal sent by a first NF is received.

The detailed description of step 201c may refer to the above embodiment of FIG. 2a.

At step 202c: the first information of the terminal is sent to a network element subscribing to an update event of the first information of the terminal.

In some embodiments, the above-mentioned network element subscribing to the update event of the first information of the terminal may include an AMF network element.

In some embodiments, the second NF may be configured to store indication information of the terminal, and the indication information may indicate an allowable provision condition of the first information of the terminal. In some embodiments, the second NF may send the indication information to the first NF based on a subscription or a request of the first NF.

In some embodiments, after sending the first information of the terminal to the network element subscribing to the update event of the first information, the second NF may also send a success response message to the first NF.

The detailed description of step 202c may refer to the above embodiment of FIG. 2a.

In some embodiments, optional examples of the embodiment in FIG. 2c of the disclosure and other embodiments (such as at least one of the embodiments in FIGS. 2a and 2b, or FIGS. 3 to 6d) may be combined with each other.

In summary, according to the authorization method provided by the embodiments of the disclosure, the second NF receives the first information of the terminal sent by the first NF and sends the first information of the terminal to the network elements that have subscribed to the update event of the first information. In some embodiments, the first information of the terminal received by the second NF is sent to the second NF after the first NF receives the first information of the terminal provided by the AF and before sending the first information, when the authorizing, based on the indication information, for the AF to perform the provision procedure of the first information passes. It may be seen that after the first NF receives the first information of the terminal provided by the AF, before sending the first information, the first NF may first authorize, based on the indication information, the AF to perform the provision procedure of the first information, so as to determine whether to send the first information subsequently, thereby improving a strictness for sending the first information and avoiding a situation where “in a case where the AF provides first information of the terminal beyond its authority, but the first NF fails to identify this first information provided by the AF and directly provides the first information to the AMF network element or the MME via the second NF, resulting in a core network possibly performing a DoS attack on the terminal”, and ensuring a stability of communication.

FIG. 3a is a schematic flowchart of an authorization method according to an embodiment of the disclosure. The method is executed by a second NF. As shown in FIG. 3a, the authorization method may include the following steps.

At step 301a: first information of a terminal sent by a first NF is obtained.

In some embodiments, the first information of the terminal sent by the first NF is determined by the first NF based on a terminal information provision request sent by an AF, in which the terminal information provision request includes the first information of the terminal provisioned by the AF.

At step 302a: indication information is determined, in which the indication information indicates an allowable provision condition of the first information of the terminal.

In some embodiments, the method for determining the indication information may include at least one of:
determining, based on an identifier of the terminal, the indication information corresponding to the terminal from pre-stored indication information, in which the pre-stored indication information is determined by the second NF based on a transmission of the terminal, or the pre-stored indication information is obtained by the second NF by requesting from the terminal; or
determining, based on an identifier of the terminal, the indication information corresponding to the terminal from the pre-provisioned indication information.

At step 303a: the AF is authorized, based on the indication information, to perform a provision procedure of the first information.

The detailed description of steps 301a to 303a may refer to the above embodiment of FIG. 2a.

In some embodiments, optional examples of the embodiment in FIG. 3a of the disclosure and other embodiments (such as at least one of the embodiments in FIGS. 2a-2c, 3b, 4 to 6d) may be combined with each other.

In summary, according to the authorization method provided by the embodiments of the disclosure, after the second NF receives the first information of the terminal provided by the AF, before transmitting the first information, the second NF may first authorize, based on the indication information, the provision procedure of the first information. In some embodiments, the indication information indicates the allowable provision condition of the first information of the terminal. Then, “authorizing, based on the indication information, the AF to perform the provision procedure of the first information” may be understood as, for example, determining whether the AF has an authority to provision the first information, so as to determine, based on the authorizing result, whether to send the first information subsequently, thereby improving a strictness for sending information and avoiding a situation where “in a case where the AF provides first information of the terminal beyond its authority, but the second NF fails to identify this first information provided by the AF and directly provides the first information to the AMF network element or the MME, resulting in a core network possibly performing a DoS attack on the terminal”, and ensuring a stability of communication.

FIG. 3b is a schematic flowchart of an authorization method according to an embodiment of the disclosure. The method is executed by a second NF. As shown in FIG. 3b, the authorization method may include the following steps.

At step 301b: it is determined, based on an authorizing result, whether to send first information of a terminal.

In some embodiments, the method for determining, based on the authorizing result, whether to send the first information of the terminal may include at least one of:
in response to the authorizing passing, sending the first information of the terminal to a network element subscribing to an update event of the first information of the terminal; or
in response to the authorizing failing, terminating sending the first information of the terminal.

In some embodiments, the above-mentioned network element subscribing to the update event of the first information of the terminal may include an AMF network element.

In some embodiments, in an embodiment of the disclosure, the process of the above-mentioned “determining, based on the authorizing result, whether to send the first information of the terminal” may include: in response to the authorizing passing, sending the first information of the terminal to the network element subscribing to the update event of the first information of the terminal. In another embodiment of the disclosure, the process of the above-mentioned “determining, based on the authorizing result, whether to send the first information of the terminal” may include: in response to the authorizing failing, terminating sending the first information of the terminal. In yet another embodiment of the disclosure, the process of the above-mentioned “determining, based on the authorizing result, whether to send the first information of the terminal” may include: in response to the authorizing passing, sending the first information of the terminal to the network element subscribing to the update event of the first information of the terminal; and in response to the authorizing failing, terminating sending the first information of the terminal.

In some embodiments, after determining, based on the authorizing result, whether to send the first information of the terminal, the method may further include at least one of:
in response to the authorizing passing, the second NF sending a success response message to a first NF; or
in response to the authorizing failing, the second NF sending a rejection response message to a first NF.

In some embodiments, in an embodiment of the disclosure, after determining, based on the authorizing result, whether to send the first information of the terminal, the second NF may perform: in response to the authorizing passing, sending the success response message to the first NF. In another embodiment of the disclosure, after determining, based on the authorizing result, whether to send the first information of the terminal, the second NF may perform: in response to the authorizing failing, sending the rejection response message to the first NF. In yet another embodiment of the disclosure, after determining, based on the authorizing result, whether to send the first information of the terminal, the second NF may perform: in response to the authorizing passing, sending the success response message to the first NF; and in response to the authorizing failing, sending the rejection response message to the first NF.

In some embodiments, optional examples of the embodiment in FIG. 3b of the disclosure and other embodiments (such as at least one of the embodiments in FIGS. 2a-2c, 3a, 4 to 6d) may be combined with each other.

In summary, according to the authorization method provided by the embodiments of the disclosure, the first information is sent only when the authorizing passes, and sending the first information of the terminal is terminated when the authorizing fails. Therefore, the method of the disclosure has a high strictness for sending information, ensuring a stability of communication.

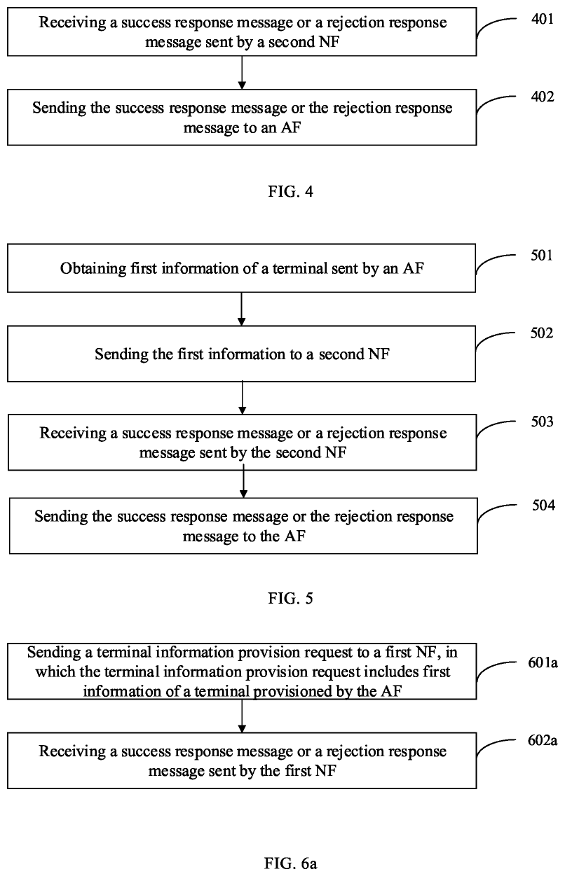

FIG. 4 is a schematic flowchart of an authorization method according to an embodiment of the disclosure. The method is executed by a first NF. As shown in FIG. 4, the authorization method may include the following step.

At step 401: a success response message or a rejection response message sent by a second NF is received.

In some embodiments, the success response message or the rejection response message may be sent by the second NF to the first NF based on its authorizing result for an AF. The detailed description of this part may refer to the description of the above embodiment in FIG. 3.

At Step 402: the success response message or the rejection response message is sent to an AF.

In some embodiments, optional examples of the embodiment in FIG. 4 of the disclosure and other embodiments (such as at least one of the embodiments in FIGS. 2a-2c, 3a, 3c, 5, 6a-6d) may be combined with each other.

In summary, according to the authorization method provided by the embodiments of the disclosure, the success response message or the rejection response message received by the first NF is sent by the second NF to the first NF based on the authorizing result of a provision procedure of the first information by the AF after the second NF receives first information of the terminal provided by the AF and before sending the first information. It may be seen that after the second NF receives the first information of the terminal provided by the AF, before sending the first information, the second NF may first authorize, based on indication information, the AF to perform the provision procedure of the first information, so as to determine whether to send the first information subsequently, thereby improving a strictness for sending the first information and avoiding a situation where “in a case where the AF provides first information of the terminal beyond its authority, but the second NF fails to identify this first information provided by the AF and directly provides the first information to the AMF network element or the MME, resulting in a core network possibly performing a DoS attack on the terminal”, and ensuring a stability of communication.

FIG. 5 is a schematic flowchart of an authorization method according to an embodiment of the disclosure. The method is executed by a first NF. As shown in FIG. 5, the authorization method may include the following steps.

At step 501: first information of a terminal sent by an AF is obtained.

At step 502: the first information is sent to a second NF.

A step 503: a success response message or a rejection response message sent by the second NF is received.

At step 504: the success response message or the rejection response message is sent to the AF.

The detailed description of steps 501 to 504 may refer to the above embodiments of FIGS. 2a to 4.

In some embodiments, optional examples of the embodiment in FIG. 5 of the disclosure and other embodiments (such as at least one of the embodiments in FIGS. 2a-2c, 3a, 3c, 4, 6a-6d) may be combined with each other.

In summary, according to the authorization method provided by the embodiments of the disclosure, the success response message or the rejection response message received by the first NF is sent by the second NF to the first NF based on an authorizing result of a provision procedure of the first information by the AF after the second NF receives the first information of the terminal provided by the AF and before sending the first information. It may be seen that after the second NF receives the first information of the terminal provided by the AF, before sending the first information, the second NF may first authorize, based on indication information, the AF to perform the provision procedure of the first information, so as to determine whether to send the first information subsequently, thereby improving a strictness for sending the first information and avoiding a situation where “in a case where the AF provides first information of the terminal beyond its authority, but the second NF fails to identify this first information provided by the AF and directly provides the first information to the AMF network element or the MME, resulting in a core network possibly performing a DoS attack on the terminal”, and ensuring a stability of communication.

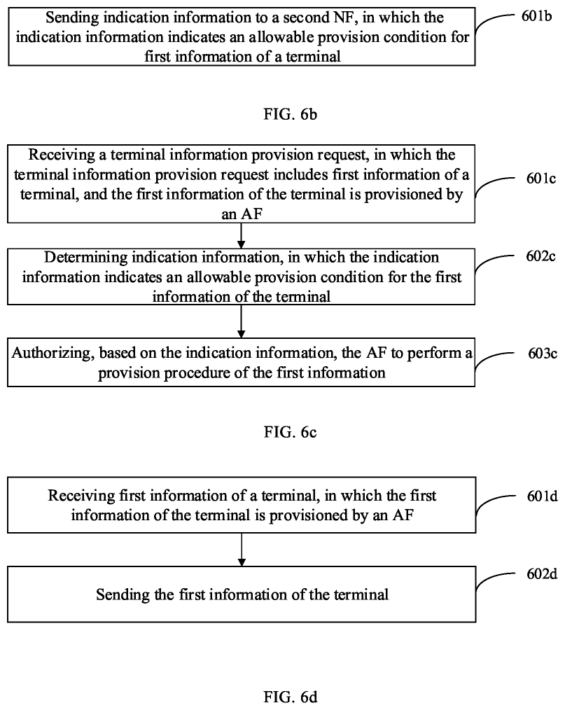

FIG. 6a is a schematic flowchart of an authorization method according to an embodiment of the disclosure. The method is executed by an AF. As shown in FIG. 6b, the authorization method may include the following steps.

At step 601a: a terminal information provision request is sent to a first NF, in which the terminal information provision request includes first information of a terminal provisioned by the AF.

The detailed description for the terminal information provision request and the first information of the terminal may refer to the above embodiments of FIGS. 2a to 2c.

At step 602a: a success response message or a rejection response message sent by the first NF is received.

In some embodiments, optional examples of the embodiment in FIG. 6a of the disclosure and other embodiments (such as at least one of the embodiments in FIGS. 2a-5, or FIGS. 6b-6d) may be combined with each other.

In summary, according to the authorization method provided by the embodiments of the disclosure, the success response message or the rejection response message received by the AF may be sent to the first NF by a second NF based on an authorizing result of a provision procedure of the first information by the AF after the second NF receives the first information of the terminal provided by the AF and before sending the first information, or may be sent to the first NF by the first NF based on an authorizing result of a provision procedure of the first information by the AF after the first NF receives the first information of the terminal provided by the AF and before sending the first information. It may be seen that after the first NF or the second NF receives the first information of the terminal provided by the AF, before sending the first information, the AF may be first authorized, based on indication information, to perform the provision procedure of the first information, so as to determine whether to send the first information subsequently, thereby improving a strictness for sending the first information and avoiding a situation where “in a case where the AF provides first information of the terminal beyond its authority, but this first information provided by the AF is not identified, the first information is directly provided to the AMF network element or the MME, resulting in a core network possibly performing a DoS attack on the terminal”, and ensuring a stability of communication.

FIG. 6b is a schematic flowchart of an authorization method according to an embodiment of the disclosure. The method is executed by a terminal. As shown in FIG. 6b, the authorization method may include the following steps.

At step 601b: indication information is sent to a second NF, in which the indication information indicates an allowable provision condition for first information of a terminal.

In some embodiments, the above mentioned “sending the indication information to the second NF” may include: sending the indication information to the second NF via an AMF network element.

The detailed description for the step 601b may refer to the above embodiment of FIG. 2a.

In some embodiments, optional examples of the embodiment in FIG. 6b of the disclosure and other embodiments (such as at least one of the embodiments in FIGS. 2a-5, or FIGS. 6a, 6c, 6d) may be combined with each other.

In summary, according to the authorization method provided by the embodiments of the disclosure, the terminal may send the indication information to the second NF, so that the second NF may authorize, based on the indication information, an AF to perform a provision procedure for the first information to determine whether to send the first information. Alternatively, this allows the second NF to send the indication information to the first NF, enabling the first NF to authorize, based on the indication information, the AF to perform the provision procedure of the first information to determine whether to send the first information. The disclosure improves a strictness for sending the first information and avoiding a situation where “in a case where the AF provides first information of the terminal beyond its authority, but this first information provided by the AF is not identified, the first information is directly provided to the AMF network element or the MME, resulting in a core network possibly performing a DoS attack on the terminal”, which ensures a stability of communication.

FIG. 6c is a schematic flowchart of an authorization method according to an embodiment of the disclosure. The method is executed by a first device. As shown in FIG. 6c, the authorization method may include the following steps.

At step 601c: a terminal information provision request is received, in which the terminal information provision request includes first information of a terminal, and the first information of the terminal is provisioned by an AF.

At step 602c: indication information is determined, in which the indication information indicates an allowable provision condition for the first information of the terminal.

At step 603c: the AF is authorized, based on the indication information, to perform a provision procedure of the first information.

In some embodiments, the indication information includes at least one of:
an identifier of at least one target AF, in which the target AF is an AF allowed to provision the first information of the terminal;
an identifier of the terminal;
at least one piece of second information, in which the second information indicates information allowed to be provisioned for the terminal;
an expected service identifier indicating that the terminal allows the target AF to process the second information with an expected service corresponding to the expected service identifier;
an expected service operation identifier indicating that the terminal allows the target AF to process the second information with an expected service operation corresponding to the expected service operation identifier;
a valid time of the indication information;
an expiration time of the indication information; or
an authorization policy comprising that the terminal allows the target AF to process the second information with the expected service and/or the expected service operation.

The relevant introduction about the indication information may refer to the description for the above embodiments.

In some embodiments, the terminal information provision request further includes at least one of:
an identifier of the AF that provisions the first information;
an identifier of the terminal;
a first service identifier corresponding to the first information, in which the first service identifier indicates that the AF processes the first information with a service corresponding to the first service identifier; or
a first service operation identifier corresponding to the first information, in which the first service operation identifier indicates that the AF processes the first information with a service operation corresponding to the first service operation identifier.

The relevant introduction about the terminal information provision request may refer to the description for the above embodiments.

In some embodiments, in response to the indication information including the identifier of at least one target AF, authorizing, based on the indication information, the AF to perform the provision procedure of the first information includes at least one of:
determining whether an AF for provisioning the first information is the target AF, and determining whether the first information is the second information;
in response to the first information being not the second information and/or the AF for provisioning the first information being not the target AF, determining that the authorizing fails; or
in response to the AF for provisioning the first information being the target AF and the first information being the second information, determining whether the authorizing passes or fails based on whether the indication information includes at least one of the expected service identifier or the expected service operation identifier, and/or based on whether the terminal information provision request includes at least one of the first service identifier or the first service operation identifier.

The detailed description about “authorizing, based on the indication information, the AF to perform the provision procedure of the first information” may refer to the description of the above embodiments.

In some embodiments, in response to the indication information not including the identifier of at least one target AF, authorizing, based on the indication information, the AF to perform the provision procedure of the first information includes at least one of:
determining whether the first information is the second information;
in response to the first information being not the second information, determining that the authorizing fails; or
in response to the first information being the second information, determining whether the authorizing passes or fails based on whether the indication information includes at least one of the expected service identifier or the expected service operation identifier, and/or based on whether the terminal information provision request includes at least one of the first service identifier or the first service operation identifier.

The detailed description about “authorizing, based on the indication information, the AF to perform the provision procedure of the first information” may refer to the description of the above embodiments.

In some embodiments, determining whether the authorizing passes or fails based on whether the indication information includes at least one of the expected service identifier or the expected service operation identifier, and/or based on whether the terminal information provision request includes at least one of the first service identifier or the first service operation identifier includes at least one of:
in response to the indication information not including the expected service identifier or the expected service operation identifier, determining that the authorizing passes;
in response to the indication information including the expected service identifier and the terminal information provision request including the first service identifier, determining whether the first service identifier belongs to the expected service identifier, and in a case where the first service identifier belongs to the expected service identifier, determining that the authorizing passes, and in a case where the first service identifier does not belong to the expected service identifier, determining that the authorizing fails;
in response to the indication information including the expected service operation identifier and the terminal information provision request including the first service operation identifier, determining whether the first service operation identifier belongs to the expected service operation identifier, and in a case where the first service operation identifier belongs to the expected service operation identifier, determining that the authorizing passes, and in a case where the first service operation identifier does not belong to the expected service operation identifier, determining that the authorizing fails;
in response to the indication information including the expected service identifier and the expected service operation identifier, and the terminal information provision request including the first service identifier and the first service operation identifier, determining whether the first service identifier belongs to the expected service identifier and whether the first service operation identifier belongs to the expected service operation identifier, and in a case where the first service identifier belongs to the expected service identifier and the first service operation identifier belongs to the expected service operation identifier, determining that the authorizing passes, and in a case where the first service identifier does not belong to the expected service identifier or the first service operation identifier does not belong to the expected service operation identifier, determining that the authorizing fails;
in response to the indication information including the expected service identifier and the terminal information provision request not including the first service identifier, determining that the authorizing fails; or
in response to the indication information including the expected service operation identifier and the terminal information provision request not including the first service operation identifier, determining that the authorizing fails.

The detailed description about “determining whether the authorizing passes or fails” may refer to the description of the above embodiments.

In some embodiments, the second information is unreachability period information of the terminal.

In some embodiments, in response to the first information being unreachability period information of the terminal,
information content corresponding to the first information includes at least one of:
a maximum waiting time corresponding to a transmission of the terminal;
a maximum response time of the terminal to information;
a time the terminal is in coverage of a communication signal; or
a time the terminal is out of coverage of a communication signal.

The detailed description about the first information and the second information may refer to the description of the above embodiments.

In some embodiments, the method further includes:
determining, based on an authorizing result, whether to send the first information of the terminal.

The detailed description about “determining, based on the authorizing result, whether to send the first information of the terminal” may refer to the description of the above embodiments.

In some embodiments, the first device is a first NF; or the first device is a second NF.

In some embodiments, in response to the first device being the first NF, determining the indication information corresponding to the terminal includes at least one of:
determining, based on an identifier of the terminal, the indication information corresponding to the terminal from pre-provisioned indication information; or
determining, based on an identifier of the terminal, the indication information corresponding to the terminal from pre-stored indication information, in which the pre-stored indication information is obtained by the first NF by subscribing to or requesting from a second NF.

In some embodiments, in response to the first device being the first NF, determining, based on an authorizing result, whether to send the first information of the terminal includes at least one of:
in response to the authorizing passing, sending the first information of the terminal to a second NF; or
in response to the authorizing failing, terminating sending the first information of the terminal and sending a rejection response message to the AF.

In some embodiments, in response to the first device being the first NF, the method further includes:
receiving a success response message sent by a second NF; and
sending the success response message to the AF.

In some embodiments, the first NF includes at least one of:
an NEF;
a CAPIF core function;
an authorization function; or
an AEF;
the second NF includes at least one of:
an UDM; or
an UDR.

In some embodiments, in response to the first device being the second NF, determining the indication information corresponding to the terminal includes at least one of:
determining, based on an identifier of the terminal, the indication information corresponding to the terminal from pre-stored indication information, in which the pre-stored indication information is determined by the second NF based on a transmission of the terminal, or the pre-stored indication information is obtained by the second NF by requesting from the terminal; or
determining, based on an identifier of the terminal, the indication information corresponding to the terminal from pre-provisioned indication information.

In some embodiments, in response to the first device being the second NF, determining, based on the authorizing result, whether to send the first information of the terminal includes at least one of:
in response to the authorizing passing, sending the first information of the terminal to a network element subscribing to an update event of the first information of the terminal; or
in response to the authorizing failing, terminating sending the first information of the terminal.

In some embodiments, the network element subscribing to the update event of the first information of the terminal includes: an AMF network element.

In some embodiments, in response to the first device being the second NF, the method further includes at least one of:
in response to the authorizing passing, sending a success response message to a first NF; or
in response to the authorizing failing, sending a rejection response message to a first NF.

In some embodiments, in response to the first device being the second NF, the method further includes:
receiving the indication information sent by the terminal;
in which receiving the indication information sent by the terminal includes:
receiving the indication information sent by the terminal via an AMF network element.

The relevant introduction about the above optional examples may refer to the description for the above embodiments.

In some embodiments, optional examples of the embodiment in FIG. 6c of the disclosure and other embodiments (such as at least one of the embodiments in FIGS. 2a-5, or FIGS. 6a, 6b, 6d) may be combined with each other.

In summary, the authorization method according the embodiments of the disclosure may be used to authorize, based on the authorization method, the AF to perform the provision procedure of the first information, so as to determine, based on the authorizing result, whether to send the first information subsequently, thereby improving a strictness for sending information and ensuring a stability of communication.

FIG. 6d is a schematic flowchart of an authorization method according to an embodiment of the disclosure. The method is executed by a second device. As shown in FIG. 6d, the authorization method may include the following steps.

At step 601d, first information of a terminal is received, in which the first information of the terminal is provisioned by an AF.

At step 602d, the first information of the terminal is sent.

In some embodiments, the second device is a second NF; or the second device is a first NF.

In some embodiments, in response to the second device being the second NF, receiving the first information of the terminal includes:
receiving the first information of the terminal sent by a first NF;
in which sending the first information of the terminal includes:
sending the first information of the terminal to a network element subscribing to an update event of the first information of the terminal.

In some embodiments, in response to the second device being the second NF, the method further includes:
sending indication information to a first NF based on a subscription or a request of the first NF, in which the indication information indicates an allowable provision condition for the first information of the terminal.

In some embodiments, the network element subscribing to the update event of the first information of the terminal includes: an AMF network element.

In some embodiments, in response to the second device being the second NF, the method further includes:
sending a success response message to a first NF.

In some embodiments, in response to the second device being the first NF, receiving the first information of the terminal includes:
receiving a terminal information provision request sent by the AF, in which the terminal information provision request includes the first information of the terminal, and the first information of the terminal is provisioned by the AF;
in which sending the first information of the terminal includes:
sending the terminal information provision request to a second NF.

In some embodiments, in response to the second device being the first NF, the method further includes:
receiving a success response message or a rejection response message sent by a second NF; and
sending the success response message or the rejection response message to the AF.

The relevant introduction about the above optional examples may refer to the description for the above embodiments.

In some embodiments, optional examples of the embodiment in FIG. 6d of the disclosure and other embodiments (such as at least one of the embodiments in FIGS. 2a-5, or FIGS. 6a, 6b, 6c) may be combined with each other.

In summary, according to the authorization method provided by the embodiments of the disclosure, the second device receives the first information of the terminal provisioned by the AF, and then sends the first information of the terminal. In some embodiments, the first information received by the second device may be sent to the second device by a first device when the first device authorizes, based on the indication information, the AF to perform a provision procedure for the first information, or the second device sends the first information to the first device, so that the first device is enable to authorize, based on the indication information, the AF to perform the provision procedure for the first information, so as to determine whether to send the first information subsequently. Therefore, the authorization method of the disclosure has a high strictness, ensuring a stability of communication.

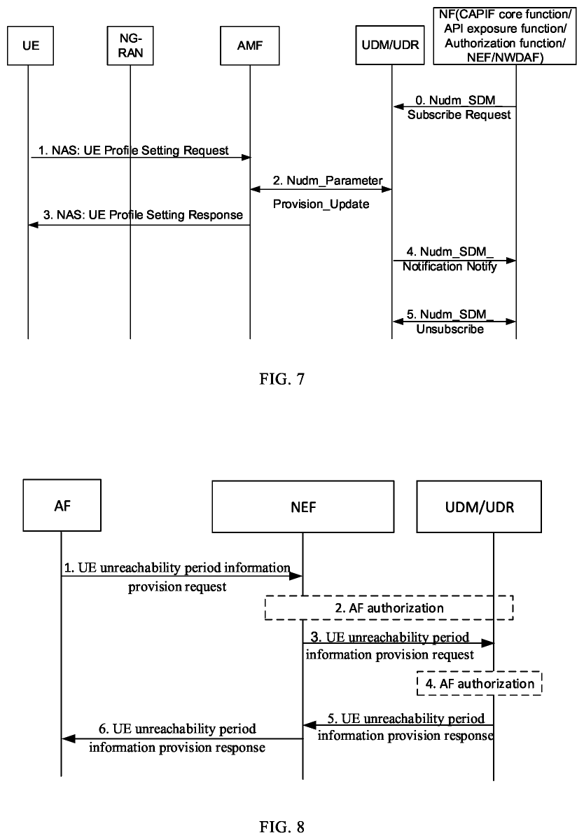

FIG. 7 is an interaction flowchart of a first NF subscribing to indication information from a second NF according to an embodiment of the disclosure. The process of the first NF subscribing to the indication information from the second NF is described by way of example in conjunction with FIG. 7 as follows.

0. An NF (i.e., the above first NF, such as CAPIF core function, authorization function in CAPIF, CAPIF, NEF, API exposure function in network data analytics function (NWDAF)) may subscribe to an UDM/UDR notification of a UE profile (i.e., the above indication information) update.

1. If the UE (i.e., the above terminal) has generated or updated the UE profile, the UE sends the newly updated part of the UE profile to the AMF via the UE profile setting in an N1 NAS message.

2. The AMF invokes the Nudm_ParameterProvision_Update service operation towards the UDM/UDR (i.e., the above second NF), and the service operation carries the updated part of the UE profile. The UDM/UDR stores or updates the UE profile in the UDR by invoking a Nudr_DM_Update (SUPI, subscription data) service operation accordingly.

3. The AMF responds to the UE via a UE profile setting response in the N1 NAS message.

4. The UDM/UDR notifies the subscribed network function of the updated UE profile via an Nudm_SDM_Notification notification message.

5. The NF (e.g., CAPIF core function, authorization function in CAPIF, API exposure function, NEF, NWDAF) may unsubscribe to an UDM/UDR notification of the UE profile.

The UE profile is stored in the UDM/UDR. For each UE, the UE profile determines whether a specific AF is able to provide specific information related to a specific UE. The UE profile includes an AF identifier (e.g., AF_ID, application layer ID, or FQDN), an expected service (e.g., Nnef_ParameterProvision), a target UE identifier (e.g., SUPI, SUCI, IMPI, application layer ID of the UE, or GPSI), UE unreachability period information, an expiration time (expiration), and an authorization policy (e.g., a specific AF is able to provide UE unreachability period information).

FIG. 8 is an interaction flowchart of an authorization method according to an embodiment of the disclosure. The method of the disclosure is described by way of example in conjunction with FIG. 8 as follows.

1. An AF sends a UE unreachability period information provision request to an NEF. The request includes an AF identifier (e.g., AF_ID, application layer ID, or FQDN), a target UE identifier (e.g., IMPI, application layer ID of UE, or GPSI), and UE unreachability period information. The UE unreachability period information may include information such as a maximum waiting time and a maximum response. The information may also include information related to when the UE is expected to have coverage and when the UE is expected to be out of coverage.

2. If the UDM/UDR is used to authorize the UE unreachability period information provision procedure, step 2 can be skipped. Upon receiving the request, the NEF identifies the UE profile based on the target UE identity. If the NEF does not contain the UE profile, the NEF obtains the profile according to clause 2.1 of this document. The NEF leverages the UE profile to check whether the UE authorizes the AF to provision the UE unreachability period information to 5GS. The NEF can also leverage the local policies to check whether the AF is authorized to provision the UE unreachability period information to the 5GS. If the AF is authorized to provision the UE unreachability period information to the 5GS, the procedure goes to step 3. Otherwise, the NEF terminates the procedure.

3. The NEF sends the UE unreachability period information provision request to the UDM/UDR.

4. If the NEF is utilized to authorize the UE unreachability period information provision procedure, step 4 can be skipped. Upon receiving the request, the UDM/UDR identifies the UE profile based on the target UE identity. The UDM/UDR leverages the UE profile to check whether the UE authorizes the AF to provision the UE unreachability period information to the 5GS. The UDM/UDR can also leverage the local policies to check whether the AF is authorized to access 5GC assistance information. If the AF is authorized to provision the UE unreachability period information to the 5GS, the procedure goes to step 5. Otherwise, the UDM/UDR terminates the procedure.

5. If the AF is authorized to provision the information, the UDM/UDR stores the UE unreachability period information. The UDM/UDR sends the UE unreachability period information provision response to the NEF.

6. The NEF sends the UE unreachability period information provision response to the AF.

In some embodiments, in an embodiment of the disclosure, the UDM/UDR should be able to store the UE profile. The UDM/UDR leverages the UE profile to check whether the UE authorizes the AF to provision the UE unreachability period information to the 5GS. The UDM/UDR may also leverages the local policies to check whether the AF is authorized to access the 5GC assistance information.

In some embodiments, in an embodiment of the disclosure, upon receiving the request, the NEF identifies the UE profile based on the target UE identity. If the NEF does not contain the UE profile, the NEF obtains the profile according to clause 2.1 of this document. The NEF leverages the UE profile to check whether the UE authorizes the AF to provision the UE unreachability period information to 5GS. The NEF can also leverage the local policies to check whether the AF is authorized to provision the UE unreachability period information to the 5GS.

In some embodiments, any step in the above embodiments (such as at least one of the embodiments in FIGS. 2a to 8) may serve as a separate embodiment. Without conflict, different steps in the same embodiment and different steps in different embodiments may be combined arbitrarily and/or their order may be interchanged, and the solutions resulting from such recombination are also within the protection scope of the disclosure.

In some embodiments, in an embodiment of the disclosure, the above authorization method may include the following steps.

At step A: a terminal information provision request is received, in which the terminal information provision request includes first information of a terminal, and the first information of the terminal is provisioned by an AF.

At step B: indication information is determined, in which the indication information indicates an allowable provision condition for the first information of the terminal.

At step C: whether to send the first information is authorized based on the indication information.

In some embodiments, in an embodiment of the disclosure, the above-mentioned “authorizing whether to send the first information based on the indication information” may be understood as, for example: authorizing whether to send the first information by determining whether the AF provisioning the first information has an authority to provision the first information.

The detailed introduction of the above step A to step B may refer the contents of the above embodiments in FIGS. 2a-6d.

In some embodiments, any step of the above step A, step B, and step C may be acted as a separate embodiment. Without conflict, step A, step B, and step C may be arbitrarily combined with different steps of the embodiments in FIGS. 2a-6d and/or the order of the steps may be interchanged. The solutions resulting from such recombination are also within the protection scope of the disclosure.

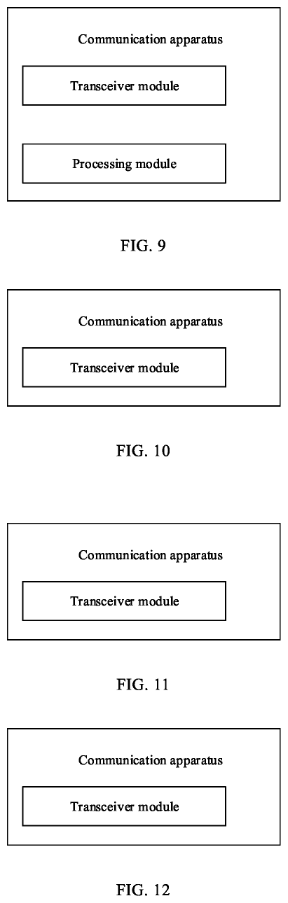

FIG. 9 is a schematic diagram of an authorization apparatus according to an embodiment of the disclosure. As shown in FIG. 9, the apparatus may include:
a transceiver module, configured to receive a terminal information provision request, in which the terminal information provision request includes first information of a terminal, and the first information of the terminal is provisioned by an AF; and
a processing module, configured to determine indication information, in which the indication information indicates an allowable provision condition for the first information of the terminal;
in which the processing module is further configured to authorize, based on the indication information, the AF to perform a provision procedure of the first information.

In summary, the authorization apparatus according the embodiments of the disclosure may be configured to authorize, based on the authorization method, the AF to perform the provision procedure of the first information, so as to determine, based on an authorizing result, whether to send the first information subsequently, thereby improving a strictness for sending information and ensuring a stability of communication.

In some embodiments, in an embodiment of the disclosure, the indication information includes at least one of:
an identifier of at least one target AF, in which the target AF is an AF allowed to provision the first information of the terminal;
an identifier of the terminal;
at least one piece of second information, in which the second information indicates information allowed to be provisioned for the terminal;
an expected service identifier indicating that the terminal allows the target AF to process the second information with an expected service corresponding to the expected service identifier;
an expected service operation identifier indicating that the terminal allows the target AF to process the second information with an expected service operation corresponding to the expected service operation identifier;
a valid time of the indication information;
an expiration time of the indication information; or
an authorization policy comprising that the terminal allows the target AF to process the second information with the expected service and/or the expected service operation.

In some embodiments, in an embodiment of the disclosure, the terminal information provision request further includes at least one of:
an identifier of the AF that provisions the first information;
an identifier of the terminal;
a first service identifier corresponding to the first information, in which the first service identifier indicates that the AF processes the first information with a service corresponding to the first service identifier; or
a first service operation identifier corresponding to the first information, in which the first service operation identifier indicates that the AF processes the first information with a service operation corresponding to the first service operation identifier.

In some embodiments, in an embodiment of the disclosure, in response to the indication information including the identifier of at least one target AF, the processing module is further configured to perform at least one of:
determining whether an AF for provisioning the first information is the target AF, and determining whether the first information is the second information;
in response to the first information being not the second information and/or the AF for provisioning the first information being not the target AF, determining that the authorizing fails; or
in response to the AF for provisioning the first information being the target AF and the first information being the second information, determining whether the authorizing passes or fails based on whether the indication information includes at least one of the expected service identifier or the expected service operation identifier, and/or based on whether the terminal information provision request includes at least one of the first service identifier or the first service operation identifier.

In some embodiments, in an embodiment of the disclosure, in response to the indication information not including the identifier of at least one target AF, the processing module is further configured to perform at least one of:
determining whether the first information is the second information;
in response to the first information being not the second information, determining that the authorizing fails; or
in response to the first information being the second information, determining whether the authorizing passes or fails based on whether the indication information includes at least one of the expected service identifier or the expected service operation identifier, and/or based on whether the terminal information provision request includes at least one of the first service identifier or the first service operation identifier.

In some embodiments, in an embodiment of the disclosure, the processing module is further configured to perform at least one of:
in response to the indication information not including the expected service identifier or the expected service operation identifier, determining that the authorizing passes;
in response to the indication information including the expected service identifier and the terminal information provision request including the first service identifier, determining whether the first service identifier belongs to the expected service identifier, and in a case where the first service identifier belongs to the expected service identifier, determining that the authorizing passes, and in a case where the first service identifier does not belong to the expected service identifier, determining that the authorizing fails;
in response to the indication information including the expected service operation identifier and the terminal information provision request including the first service operation identifier, determining whether the first service operation identifier belongs to the expected service operation identifier, and in a case where the first service operation identifier belongs to the expected service operation identifier, determining that the authorizing passes, and in a case where the first service operation identifier does not belong to the expected service operation identifier, determining that the authorizing fails;
in response to the indication information including the expected service identifier and the expected service operation identifier, and the terminal information provision request including the first service identifier and the first service operation identifier, determining whether the first service identifier belongs to the expected service identifier and whether the first service operation identifier belongs to the expected service operation identifier, and in a case where the first service identifier belongs to the expected service identifier and the first service operation identifier belongs to the expected service operation identifier, determining that the authorizing passes, and in a case where the first service identifier does not belong to the expected service identifier or the first service operation identifier does not belong to the expected service operation identifier, determining that the authorizing fails;
in response to the indication information including the expected service identifier and the terminal information provision request not including the first service identifier, determining that the authorizing fails; or
in response to the indication information including the expected service operation identifier and the terminal information provision request not including the first service operation identifier, determining that the authorizing fails.

In some embodiments, the second information is unreachability period information of the terminal.

In some embodiments, in response to the first information being unreachability period information of the terminal,
information content corresponding to the first information includes at least one of:
a maximum waiting time corresponding to a transmission of the terminal;
a maximum response time of the terminal to information;
a time the terminal is in coverage of a communication signal; or
a time the terminal is out of coverage of a communication signal.

In some embodiments, the apparatus is further configured to perform:
determining, based on an authorizing result, whether to send the first information of the terminal.

In some embodiments, the first device is a first NF; or the first device is a second NF.

In some embodiments, in response to the first device being the first NF, the processing module is further configured to perform at least one of:
determining, based on an identifier of the terminal, the indication information corresponding to the terminal from pre-provisioned indication information; or
determining, based on an identifier of the terminal, the indication information corresponding to the terminal from pre-stored indication information, in which the pre-stored indication information is obtained by the first NF by subscribing to or requesting from a second NF.

In some embodiments, in response to the first device being the first NF, the apparatus is further configured to perform at least one of:
in response to the authorizing passing, sending the first information of the terminal to a second NF; or
in response to the authorizing failing, terminating sending the first information of the terminal and sending a rejection response message to the AF.

In some embodiments, in response to the first device being the first NF, the apparatus is further configured to perform:
receiving a success response message sent by a second NF; and
sending the success response message to the AF.

In some embodiments, the first NF includes at least one of:
an NEF;
a CAPIF core function;
an authorization function; or
an AEF;
the second NF includes at least one of:
an UDM; or
an UDR.

In some embodiments, in response to the first device being the second NF, the processing module is further configured to perform at least one of:
determining, based on an identifier of the terminal, the indication information corresponding to the terminal from pre-stored indication information, in which the pre-stored indication information is determined by the second NF based on a transmission of the terminal, or the pre-stored indication information is obtained by the second NF by requesting from the terminal; or
determining, based on an identifier of the terminal, the indication information corresponding to the terminal from pre-provisioned indication information.

In some embodiments, in response to the first device being the second NF, the apparatus is further configured to perform:
in response to the authorizing passing, sending the first information of the terminal to a network element subscribing to an update event of the first information of the terminal; or
in response to the authorizing failing, terminating sending the first information of the terminal.

In some embodiments, the network element subscribing to the update event of the first information of the terminal includes: an AMF network element.

In some embodiments, in response to the first device being the second NF, the apparatus is further configured to perform:
in response to the authorizing passing, sending a success response message to a first NF; or
in response to the authorizing failing, sending a rejection response message to a first NF.

In some embodiments, in response to the first device being the second NF, the apparatus is further configured to perform:
receiving the indication information sent by the terminal;
in which receiving the indication information sent by the terminal includes:
receiving the indication information sent by the terminal via an AMF network element.

FIG. 10 is a schematic diagram of an authorization apparatus according to an embodiment of the disclosure. As shown in FIG. 10, the apparatus may include:
a transceiver module, configured to receive first information of a terminal, in which the first information of the terminal is provisioned by an AF;
in which the transceiver module is further configured to send the first information of the terminal.

In summary, in the authorization apparatus provided by the embodiments of the disclosure, the second device receives the first information of the terminal provisioned by the AF, and then sends the first information of the terminal. In some embodiments, the first information received by the second device may be sent to the second device by a first device when the first device authorizes, based on the indication information, the AF to perform a provision procedure for the first information, or the second device sends the first information to the first device, so that the first device is enable to authorize, based on the indication information, the AF to perform the provision procedure for the first information, so as to determine whether to send the first information subsequently. Therefore, the authorization method of the disclosure has a high strictness, ensuring a stability of communication.

In some embodiments, the second device is a second NF; or the second device is a first NF.

In some embodiments, in response to the second device being the second NF, the transceiver module is further configured to perform:
receiving the first information of the terminal sent by a first NF;
in which sending the first information of the terminal includes:
sending the first information of the terminal to a network element subscribing to an update event of the first information of the terminal.

In some embodiments, in response to the second device being the second NF, the apparatus is further configured to perform:
sending indication information to a first NF based on a subscription or a request of the first NF, in which the indication information indicates an allowable provision condition for the first information of the terminal.

In some embodiments, the network element subscribing to the update event of the first information of the terminal includes: an AMF network element.

In some embodiments, in response to the second device being the second NF, the apparatus is further configured to perform:
sending a success response message to a first NF.

In some embodiments, in response to the second device being the first NF, the transceiver module is further configured to perform:
receiving a terminal information provision request sent by the AF, in which the terminal information provision request includes the first information of the terminal, and the first information of the terminal is provisioned by the AF;
in which sending the first information of the terminal includes:
sending the terminal information provision request to a second NF.

In some embodiments, in response to the second device being the first NF, the apparatus is further configured to perform:
receiving a success response message or a rejection response message sent by a second NF; and
sending the success response message or the rejection response message to the AF.

FIG. 11 is a schematic diagram of an authorization apparatus according to an embodiment of the disclosure. As shown in FIG. 11, the apparatus may include:
a transceiver module, configured to send a terminal information provision request to a first N), in which the terminal information provision request includes first information of a terminal provisioned by an AF;
in which the transceiver module is further configured to receive a success response message or a rejection response message sent by the first NF.

In summary, in the authorization apparatus provided by the embodiments of the disclosure, the success response message or the rejection response message received by the AF may be sent to the first NF by a second NF based on an authorizing result of a provision procedure of the first information by the AF after the second NF receives the first information of the terminal provided by the AF and before sending the first information, or may be sent to the first NF by the first NF based on an authorizing result of a provision procedure of the first information by the AF after the first NF receives the first information of the terminal provided by the AF and before sending the first information. It may be seen that after the first NF or the second NF receives the first information of the terminal provided by the AF, before sending the first information, the AF may be first authorized, based on indication information, to perform the provision procedure of the first information, so as to determine whether to send the first information subsequently, thereby improving a strictness for sending the first information and avoiding a situation where “in a case where the AF provides first information of the terminal beyond its authority, but this first information provided by the AF is not identified, the first information is directly provided to the AMF network element or the MME, resulting in a core network possibly performing a DoS attack on the terminal”, and ensuring a stability of communication.

FIG. 12 is a schematic diagram of an authorization apparatus according to an embodiment of the disclosure. As shown in FIG. 12, the apparatus may include:
a transceiver module, configured to send indication information to a second NF, in which the indication information indicates an allowable provision condition for first information of the terminal.

In summary, in the authorization apparatus provided by the embodiments of the disclosure, the terminal may send the indication information to the second NF, so that the second NF may authorize, based on the indication information, an AF to perform a provision procedure for the first information to determine whether to send the first information. Alternatively, this allows the second NF to send the indication information to the first NF, enabling the first NF to authorize, based on the indication information, the AF to perform the provision procedure of the first information to determine whether to send the first information. The disclosure improves a strictness for sending the first information and avoiding a situation where “in a case where the AF provides first information of the terminal beyond its authority, but this first information provided by the AF is not identified, the first information is directly provided to the AMF network element or the MME, resulting in a core network possibly performing a DoS attack on the terminal”, which ensures a stability of communication.

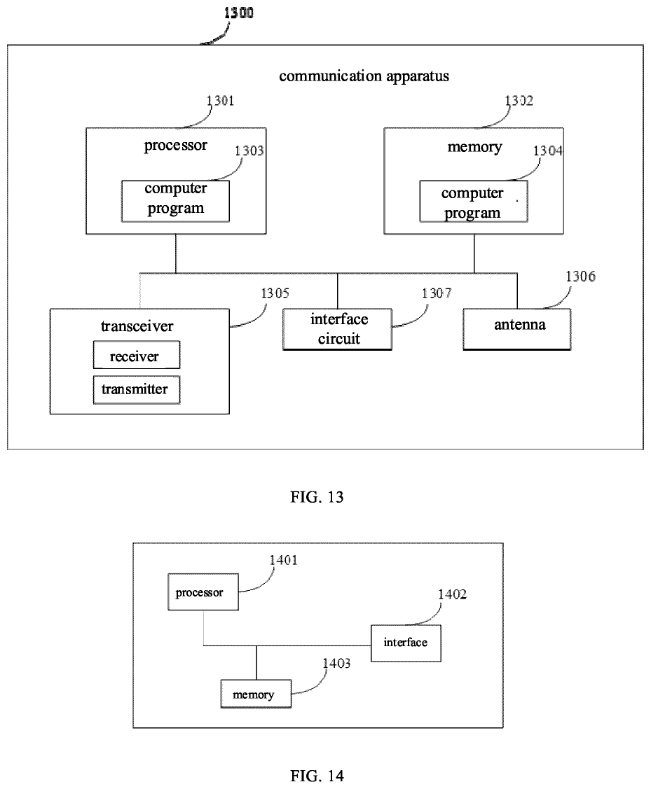

FIG. 13 is a schematic diagram of a communication apparatus 1300 according to another embodiment of the disclosure. The communication apparatus 1300 may be a network device, a terminal, or a chip, a chip system or a processor that supports the network device to realize the above-described method, or a chip, a chip system or a processor that supports the terminal to realize the above-described method. The apparatus is configured to realize the method described in the above method embodiments with reference to the descriptions of the above-described method embodiments.

The communication apparatus 1300 may include one or more processors 1301.

The processor 1301 may be a general purpose processor or a dedicated processor, such as, a baseband processor or a central processor. The baseband processor is configured for processing communication protocols and communication data. The central processor is configured for controlling communication apparatuses (e.g., base station, baseband chip, terminal, terminal chip, CU or DU), executing computer programs, and processing data of the computer programs.

In some embodiments, the communication apparatus 1300 may further include one or more memories 1302 on which a computer program 1304 may be stored. When the processor 1301 executes the computer program 1304, the communication apparatus 1300 is caused to perform the method described in the above method embodiments. In some embodiments, data may also be stored in the memory 1302. The communication apparatus 1300 and the memory 1302 may be provided separately or may be integrated together.

In some embodiments, the communication apparatus 1300 may also include a transceiver 1305 and an antenna 1306. The transceiver 1305 may be referred to as transceiver unit, transceiver machine, or transceiver circuit, for realizing a transceiver function. The transceiver 1305 may include a receiver and a transmitter. The receiver may be referred to as receiver machine or receiving circuit, for realizing a receiving function. The transmitter may be referred to as transmitter machine or transmitting circuit, for realizing a transmitting function.

In some embodiments, the communication apparatus 1300 may also include one or more interface circuits 1307. The interface circuits 1307 are configured to receive code instructions and transmit the code instructions to the processor 1301. The processor 1301 runs the code instructions to cause the communication apparatus 1300 to perform the method described in the method embodiments.

In an implementation, the processor 1301 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be configured for code/data reading and writing, or may be configured for signal transmission or delivery.

In an implementation, the processor 1301 may store a computer program 1303 that may be run by the processor 1301 and may cause the communication apparatus 1300 to perform the method described in the method embodiments above. The computer program 1303 may be solidified in the processor 1301, in which case the processor 1301 may be implemented by hardware.

In an implementation, the communication apparatus 1300 may include circuits. The circuits may implement the sending, receiving or communicating function in the preceding method embodiments. The processor and the transceiver described in the disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver may be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication apparatus in the descriptions of the above embodiments may be a network device or a terminal, but the scope of the communication apparatus described in the disclosure is not limited thereto, and the structure of the communication apparatus may not be limited by FIG. 13. The communication apparatus may be a stand-alone device or may be part of a larger device. For example, the communication apparatus may be:
(1) a stand-alone IC, chip, chip system or subsystem;
(2) a collection of ICs including one or more ICs, in some embodiments, the collection of ICs may also include storage components for storing data and computer programs;
(3) an ASIC, such as a modem;
(4) modules that may be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

The case that the communication apparatus is a chip or a chip system can refer to the schematic diagram of the chip shown in FIG. 14. The chip shown in FIG. 14 includes a processor 1401 and an interface 1402. There may be one or more processors 1401, and there are multiple interfaces 1402.

In some embodiments, the chip further includes a memory 1403 for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The disclosure also provides a non-transitory computer-readable storage medium having an instruction stored thereon. When the instruction is executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a non-transitory computer-readable storage medium or transmitted from one non-transitory computer-readable storage medium to another non-transitory computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The non-transitory computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiment of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in the disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in the disclosure may not be configured. For another example, the above tables may be adjusted appropriately, such as splitting, combining, and the like. The names of the parameters shown in the titles of the above tables may be other names that may be understood by the communication apparatus, and the values or representations of the parameters may be other values or representations that may be understood by the communication apparatus. Each of the above tables may also be implemented with other data structures, such as, arrays, queues, containers, stacks, linear tables, pointers, chained lists, trees, graphs, structures, classes, heaps, and Hash tables.

The term “predefine” in the disclosure may be understood as define, pre-define, store, pre-store, pre-negotiate, pre-configure, solidify, or pre-fire.

Those originally skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above may be referred to the corresponding processes in the preceding method embodiments, and will not be repeated herein.

The above are only specific implementations of the disclosure, but the scope of protection of the disclosure is not limited thereto. Those skilled in the art familiar to the technical field may easily think of changes or substitutions in the technical scope disclosed by the disclosure, which shall be covered by the scope of protection of the disclosure. Therefore, the scope of protection of the disclosure shall be governed by the scope of protection of the attached claims.

1. An authorization method, performed by a first device, and comprising:
receiving a terminal information provision request, wherein the terminal information provision request comprises first information of a terminal, and the first information of the terminal is provisioned by an application function (AF);
determining indication information, wherein the indication information indicates an allowable provision condition for the first information of the terminal; and
authorizing, based on the indication information, the AF to perform a provision procedure of the first information.

2. The method according to claim 1, wherein the indication information comprises at least one of:
an identifier of at least one target AF, wherein the target AF is an AF allowed to provision the first information of the terminal;
an identifier of the terminal;
at least one piece of second information, wherein the second information indicates information allowed to be provisioned for the terminal;
an expected service identifier indicating that the terminal allows the target AF to process the second information with an expected service corresponding to the expected service identifier;
an expected service operation identifier indicating that the terminal allows the target AF to process the second information with an expected service operation corresponding to the expected service operation identifier;
a valid time of the indication information;
an expiration time of the indication information; or
an authorization policy comprising that the terminal allows the target AF to process the second information with at least one of the expected service or the expected service operation.

3. The method according to claim 1, wherein the terminal information provision request further comprises at least one of:
an identifier of the AF that provisions the first information;
an identifier of the terminal;
a first service identifier corresponding to the first information, wherein the first service identifier indicates that the AF processes the first information with a service corresponding to the first service identifier; or
a first service operation identifier corresponding to the first information, wherein the first service operation identifier indicates that the AF processes the first information with a service operation corresponding to the first service operation identifier.

4. The method according to claim 2, wherein in response to the indication information comprising the identifier of at least one target AF, authorizing, based on the indication information, the AF to perform the provision procedure of the first information comprises at least one of:
determining whether an AF for provisioning the first information is the target AF, and determining whether the first information is the second information;
in response to the first information being not at least one of the second information or the AF for provisioning the first information being not the target AF, determining that the authorizing fails; or
in response to the AF for provisioning the first information being the target AF and the first information being the second information, determining whether the authorizing passes or fails based on at least one of whether the indication information comprises at least one of the expected service identifier or the expected service operation identifier, or whether the terminal information provision request comprises at least one of the first service identifier or the first service operation identifier.

5. The method according to claim 2, wherein in response to the indication information not comprising the identifier of at least one target AF, authorizing, based on the indication information, the AF to perform the provision procedure of the first information comprises at least one of:
determining whether the first information is the second information;
in response to the first information being not the second information, determining that the authorizing fails; or
in response to the first information being the second information, determining whether the authorizing passes or fails based on at least one of whether the indication information comprises at least one of the expected service identifier or the expected service operation identifier, or whether the terminal information provision request comprises at least one of the first service identifier or the first service operation identifier.

6. The method according to claim 4, wherein determining whether the authorizing passes or fails based on at least one of whether the indication information comprises at least one of the expected service identifier or the expected service operation identifier, or whether the terminal information provision request comprises at least one of the first service identifier or the first service operation identifier comprises at least one of:
in response to the indication information not comprising the expected service identifier or the expected service operation identifier, determining that the authorizing passes;
in response to the indication information comprising the expected service identifier and the terminal information provision request comprising the first service identifier, determining whether the first service identifier belongs to the expected service identifier, and in a case where the first service identifier belongs to the expected service identifier, determining that the authorizing passes, and in a case where the first service identifier does not belong to the expected service identifier, determining that the authorizing fails;
in response to the indication information comprising the expected service operation identifier and the terminal information provision request comprising the first service operation identifier, determining whether the first service operation identifier belongs to the expected service operation identifier, and in a case where the first service operation identifier belongs to the expected service operation identifier, determining that the authorizing passes, and in a case where the first service operation identifier does not belong to the expected service operation identifier, determining that the authorizing fails;
in response to the indication information comprising the expected service identifier and the expected service operation identifier, and the terminal information provision request comprising the first service identifier and the first service operation identifier, determining whether the first service identifier belongs to the expected service identifier and whether the first service operation identifier belongs to the expected service operation identifier, and in a case where the first service identifier belongs to the expected service identifier and the first service operation identifier belongs to the expected service operation identifier, determining that the authorizing passes, and in a case where the first service identifier does not belong to the expected service identifier or the first service operation identifier does not belong to the expected service operation identifier, determining that the authorizing fails;
in response to the indication information comprising the expected service identifier and the terminal information provision request not comprising the first service identifier, determining that the authorizing fails; or
in response to the indication information comprising the expected service operation identifier and the terminal information provision request not comprising the first service operation identifier, determining that the authorizing fails.

7. The method according to claim 2, wherein the second information is unreachability period information of the terminal.

8. The method according to claim 1, wherein in response to the first information being unreachability period information of the terminal, information content corresponding to the first information comprises at least one of:
a maximum waiting time corresponding to a transmission of the terminal;
a maximum response time of the terminal to information;
a time the terminal is in coverage of a communication signal; or
a time the terminal is out of coverage of a communication signal.

9. The method according to claim 1, further comprising:
determining, based on an authorizing result, whether to send the first information of the terminal.

10. The method according to claim 1, wherein the first device is a first network function (NF); or the first device is a second NF.

11. The method according to claim 10, wherein in response to the first device being the first NF, determining the indication information corresponding to the terminal comprises at least one of:
determining, based on an identifier of the terminal, the indication information corresponding to the terminal from pre-provisioned indication information; or
determining, based on an identifier of the terminal, the indication information corresponding to the terminal from pre-stored indication information, wherein the pre-stored indication information is obtained by the first NF by subscribing to or requesting from a second NF; or
wherein in response to the first device being the first NF, determining, based on an authorizing result, whether to send the first information of the terminal comprises at least one of:
in response to the authorizing passing, sending the first information of the terminal to a second NF; or
in response to the authorizing failing, terminating sending the first information of the terminal and sending a rejection response message to the AF; or
wherein in response to the first device being the first NE, the method further comprises:
receiving a success response message sent by a second NF; and
sending the success response message to the AF.

12-13. (canceled)

14. The method according to claim 10, wherein in response to the first device being the second NF, determining the indication information corresponding to the terminal comprises at least one of:
determining, based on an identifier of the terminal, the indication information corresponding to the terminal from pre-stored indication information, wherein the pre-stored indication information is determined by the second NF based on a transmission of the terminal, or the pre-stored indication information is obtained by the second NF by requesting from the terminal; or
determining, based on an identifier of the terminal, the indication information corresponding to the terminal from pre-provisioned indication information; or
wherein in response to the first device being the second NF, determining, based on the authorizing result, whether to send the first information of the terminal comprises at least one of:
in response to the authorizing passing, sending the first information of the terminal to a network element subscribing to an update event of the first information of the terminal; or
in response to the authorizing failing, terminating sending the first information of the terminal; or
wherein in response to the first device being the second NF, the method further comprises at least one of:
in response to the authorizing passing, sending a success response message to a first NF; or
in response to the authorizing failing, sending a rejection response message to a first NF; or
wherein in response to the first device being the second NF, the method further comprises:
receiving the indication information sent by the terminal;
wherein receiving the indication information sent by the terminal comprises:
receiving the indication information sent by the terminal via an AMF network element;
optionally, wherein the network element subscribing to the update event of the first information of the terminal comprises: an access and mobility management function (AMF) network element.

15-18. (canceled)

19. The method according to claim 10, wherein the first NF comprises at least one of:
a network exposure function (NEF);
a common application programming interface (API) framework (CAPIF) core function;
an authorization function; or
an API exposure function (AEF);
wherein the second NF comprises at least one of:
an unified data management (UDM); or
an unified data repository (UDR).

20. An authorization method, performed by a second device, and comprising:
receiving first information of a terminal, wherein the first information of the terminal is provisioned by an application function (AF); and
sending the first information of the terminal.

21. The method according to claim 20, wherein the second device is a second network function (NF); or the second device is a first NF.

22. The method according to claim 21, wherein in response to the second device being the second NF, receiving the first information of the terminal comprises:
receiving the first information of the terminal sent by a first NF;
wherein sending the first information of the terminal comprises:
sending the first information of the terminal to a network element subscribing to an update event of the first information of the terminal; or
wherein in response to the second device being the second NF, the method further comprises:
sending indication information to a first NF based on a subscription or a request of the first NF, wherein the indication information indicates an allowable provision condition for the first information of the terminal; or
wherein in response to the second device being the second NF, the method further comprises:
sending a success response message to a first NF;
optionally, wherein the network element subscribing to the update event of the first information of the terminal comprises: an access and mobility management function (AMF) network element.

23-25. (canceled)

26. The method according to claim 21, wherein in response to the second device being the first NF, receiving the first information of the terminal comprises:
receiving a terminal information provision request sent by the AF, wherein the terminal information provision request comprises the first information of the terminal, and the first information of the terminal is provisioned by the AF;
wherein sending the first information of the terminal comprises:
sending the terminal information provision request to a second NF; or
wherein in response to the second device being the first NF, the method further comprises:
receiving a success response message or a rejection response message sent by a second NF; and
sending the success response message or the rejection response message to the AF.

27. (canceled)

28. An authorization method, performed by an application function (AF), and comprising:
sending a terminal information provision request to a first network function (NF), wherein the terminal information provision request comprises first information of a terminal provisioned by the AF; and
receiving a success response message or a rejection response message sent by the first NF.

29-34. (canceled)

35. A communication apparatus, comprising a processor and a memory storing a computer program, wherein the processor executes the computer program stored in the memory to enable the apparatus to perform the method according to claim 1.

36. (canceled)

37. A non-transitory computer-readable storage medium for storing instructions, wherein when the instructions are executed, the method according to claim 1 is implemented.
